(19) United States
(12) Patent Application Publication
(10) Pub. No.: US 2020/0061797 A1
(43) Pub. Date: Feb. 27, 2020

(54) PLUNGE SAW

(71) Applicant: TECHTRONIC CORDLESS GP, Anderson, SC (US)

(72) Inventors: Kwok Ting MOK, Kwai Chung (HK); Zhi Qiang YE, Dongguan City (CN)

(21) Appl. No.: 16/546,780

(22) Filed: Aug. 21, 2019

(30) Foreign Application Priority Data
Aug. 23, 2018 (CN) 201821364037.2

(51) Int. Cl. B25F 5/02; B25F 5/00; B23D 45/16; B23D 45/00

(52) U.S. Cl. CPC B25F 5/02; B23D 45/003; B23D 45/16; B25F 5/001

(57) ABSTRACT

A plunge circular saw, including a cutting body and a substrate pivotally connected to the cutting body. The cutting body contains a housing; at least one handle provided on the housing; a motor received within the housing; a circular saw blade mechanically connected to the motor; a battery pack electrically connected to the motor, and a hinge for pivotally connecting the cutting body to the substrate. The battery pack is detachably mounted to a trailing end of the cutting body. The cutting body is pivotable relative to the substrate by the hinge and movable between a cutting position and a parking position. The hinge is disposed at a position between the motor or the circular saw blade and the battery pack. The circular saw provided by the present invention improves the overall parallelism of the circular saw by changing the position of the hinge and gravity distribution thereof, thereby allowing the user to cut the workpiece more easily and accurately.

### FIELD OF THE DISCLOSURE

The invention relates to a plunge circular saw. In particular, the invention relates to a portable plunge circular saw which improves overall operability by changing a position of a hinge and gravity distribution.

### BACKGROUND

Circular saws which cut a workpiece in a plunging manner are well known. Plunge circular saws are typically manually operated, and can be powered by AC or DC battery packs.

Known plunge circular saws are arranged such that a body of the circular saw can be pivoted relative to a substrate, so the circular saw can move between a cutting position and a parking position. Generally, a biasing device is provided between the body of the circular saw and the substrate and is arranged to bias the circular saw upwardly, i.e., toward the parking position. Therefore, when the user needs to start the plunge circular saw and make it cut the workpiece, it is necessary to deliberately apply the downward pressure to offset the upward biasing force of the biasing device, and also to apply the lateral thrust to advance the circular saw, which cost great effort of the user.

In addition, since a majority of the weight of the body of the circular saw is located behind the hinge, it makes the circular saw inclined to fall. Therefore, the biasing device requires a large biasing pressure to prevent the circular saw from falling down, which undoubtedly makes it difficult for the body of the circular saw to be pressed down to a cutting position, thus affecting an operation balance of the circular saw. This makes it difficult for the user to accurately operate the plunge circular saw and adjust a cutting depth thereof. For users, the above-mentioned plunge circular saw has defects in its manipulation.

### SUMMARY

The invention aims to alleviate the above technical problems related to the plunge circular saws. In particular, the present invention is directed to provide a portable, plunge circular saw which improves the overall parallelism of the circular saw by changing the position of the hinge and gravity distribution thereof, thereby allowing the user to cut the workpiece more easily and accurately.

Therefore the present invention provides a plunge circular saw including a cutting body and a substrate pivotally connected to the cutting body. The cutting body includes a housing, at least one handle provided on the housing, a motor received within the housing, a circular saw blade mechanically connected to the motor, a battery pack electrically connected to the motor, and a hinge for pivotally connecting the cutting body to the substrate. The battery pack is detachably mounted to a trailing end of the cutting body. The cutting body is pivotable relative to the substrate by the hinge and movable between a cutting position and a parking position. The hinge is disposed at a position between the motor or the circular saw blade and the battery pack.

Preferably, the hinge is disposed at a position closer to the battery pack than to the motor.

Preferably, the plunge circular saw further includes a limiting device for limiting the cutting depth, the limiting device arranged to limit a pivoting amount of the cutting body relative to the substrate. The cutting depth is adapted to be varied by adjusting the limiting device.

Preferably, the plunge circular saw further includes a biasing device disposed to bias the cutting body toward the parking position.

Preferably, the biasing device is a compression spring disposed between the cutting body and the substrate.

Preferably, the plunge circular saw further includes a locking device for locking the cutting body in the parking position, wherein the locking device is adapted to be unlocked by an unlocking block disposed on the handle to allow the cutting body to pivot relative to the substrate.

Preferably, the plunge circular saw further includes a gearbox mechanically connected to the motor and the circular saw blade.

Preferably, the plunge circular saw further includes a protective cover fixedly disposed on the substrate, the protective cover covering a part of a periphery of the circular saw blade when the circular saw blade is in the parking position.

Preferably, the plunge circular saw further includes an auxiliary handle disposed in front of the handle.

### BRIEF DESCRIPTION OF THE DRAWINGS

Embodiments of the present invention are described below by way of example with reference to the accompanying drawings, in which:

FIG. 1 is a side view of a plunge circular saw according to the prior art;

FIG. 2 is a perspective view of a plunge circular saw according to the present invention;

FIG. 3 is a side view of the plunge circular saw in a parking position in accordance with the present invention;

FIG. 4 is a side view of a plunge circular saw in a cutting position in accordance with the present invention.

### DETAILED DESCRIPTION OF PREFERRED EMBODIMENTS

The technical solutions of the present invention will be clearly and completely described in the following in conjunction with the corresponding drawings in the embodiments of the present invention. It is obvious that the described embodiments are only a part of, not all of the embodiments of the present invention. Based on the embodiments of the present invention, all other embodiments obtained by a person skilled in the art without creative efforts belong to the protection scope of the present invention.

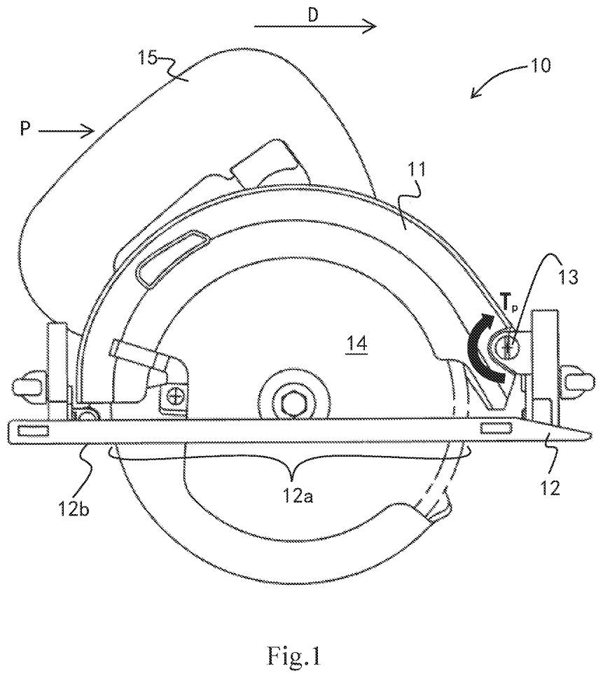

FIG. 1 shows a plunge circular saw 10 according to prior art. The plunge circular saw 10 has a cutting body 11, a substrate 12, and a hinge 13 connecting the cutting body 11 and the substrate 12. The hinge 13 is disposed at a front end of the plunge circular saw 10, that is, the end toward which the cutting direction D faces. The substrate 12 is provided with an elongated opening 12a through which a circular saw blade 14 passes and has a flat bottom surface 12b. The bottom surface 12b is arranged to enable the substrate 12 to be in contact with the workpiece or a surface of a rail. The cutting body 11 and the substrate 12 are pivotally connected by a hinge 13 disposed at the front end of the circular saw 10, such that the cutting body 11 is pivotally movable relative to the substrate 12 and movable between a cutting position and a parking position. In FIG. 1, the plunge circular saw 10 is in the parking position.

Since most of the weight of the cutting body 11, such as a motor and the gearbox, is located more posterior than the hinge 13, the cutting body 11 tends to fall (i.e. moving downwardly). Generally, a biasing device is provided between the cutting body 11 and the substrate 12 to overcome the weight of the cutting body 11 and to urge the cutting body 11 to bias upward. However, use of such a plunge circular saw 10 results in a phenomenon that when the user applies the lateral thrust P to a handle 15, the cutting body 11 tends to pivot upward relative to the substrate 12, causing the cutting body 11 to raise along with the circular saw blade 14, thereby affecting the cutting depth. Specifically, when the user pushes the handle 15 of the circular saw 10 forward, the lateral thrust P simultaneously generates a torque Tp at the hinge 13 to urge the cutting body 11 to pivot upward. Therefore, when the user cut the workpiece, the user needs to deliberately press the handle 15 down and requires a certain amount of force to overcome the resilience of the biasing device. At the same time, the user also needs to apply a forward impetus P to the handle 15 of the circular saw 10 to cause the circular saw 10 to cut forward. That is, when cutting the workpiece, the user pushes the circular saw 10 while applying a downward pressure to press the cutting body 11 to maintain the cutting body 11 at the cutting position, ensuring the consistency of the cutting depth.

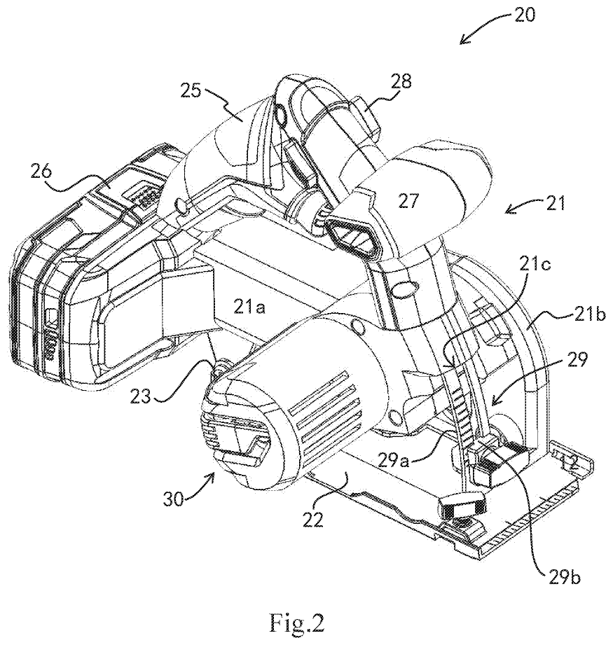

FIG. 2 shows a perspective view of a plunge circular saw 20 embodying the present invention. The circular saw 20 is a portable plunge circular saw, which has a cutting body 21 including a housing 21a, a motor 30 received in the housing 21a, and a circular saw blade 24 mechanically connected to the motor 30. A handle 25 integrally formed or fixedly connected with the housing 21a is detachably mounted to a battery pack 26 of the housing 21a and to a substrate 22 connected to the cutting body 21. The cutting body 21 and the substrate 22 are pivotally connected by a hinge 23.

The battery pack 26 is a lithium battery pack composed of a plurality of independent batteries, and is detachably mounted at the trailing end of the plunge circular saw 20. The weight of both of the battery pack 26 and the motor 30 makes up most of the total weight of the plunge circular saw 20. As shown in FIGS. 2 to 4, the hinge 23 of the circular saw 20 is disposed closer to the trailing end of the circular saw 20 and is located between the battery pack 26 and the motor 30 or the circular saw blade 24. The plunge circular saw 20 can also be provided with a gearbox that is mechanically connected to the motor 30 and the circular saw blade 24 in response to different requirements of cutting speed.

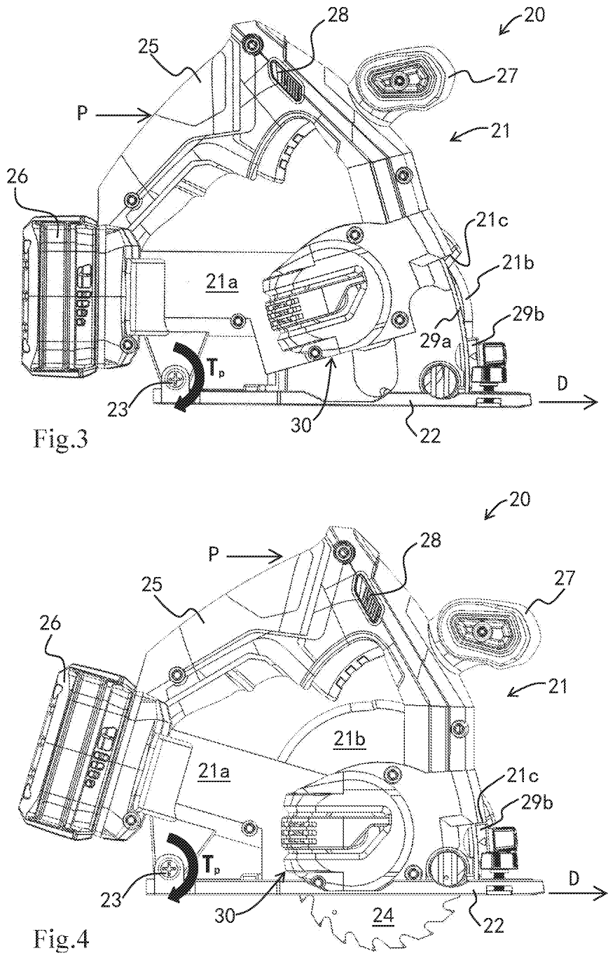

According to FIGS. 3 and 4, the hinge 23 is disposed at a position closer to the battery pack 26 than the motor 30. The position of the hinge 23 can be varied depending on different weight distribution, so that a substantial balance effect by the cutting body 21 on the hinge 23 can be achieved. Specifically, the purpose of disposing the hinge 23 between the battery pack 26 and the motor 30 is to offset the weight of the battery pack 26 and the motor 30, and the cutting body 21 as a whole can be balanced at the hinge 23, so that it is easier to operate the plunge circular saw 20, and efforts can be saved, which improves the cutting accuracy.

Unlike the prior art, when using the plunge circular saw 20 of the present invention, the user only needs to apply an unidirectional thrust P to the handle 25 to push the circular saw 20 in the cutting direction. According to FIG. 3, the lateral thrust causes the circular saw 20 to pivot forward and generate a torque Tp. Since the hinge 23 is located behind the motor 30 or the circular saw blade 24, the torque Tp causes the cutting body to pivot downward and down to the cutting position. As shown in FIG. 4, the user only needs to apply a lateral thrust to the handle 25 to advance the circular saw 20, while pressing the cutting body 21 to maintain at the cutting position, thereby achieving an effort of maintaining the cutting depth uniform. Further, the cutting body 21 is further provided with an auxiliary handle 27 at the front of the handle 25, so that the user can safely grasp the circular saw 20 with both hands when cutting, further increasing the stability thereof.

Preferably, the plunge circular saw 20 is also provided with a biasing device. The biasing device may be a compression spring disposed between the cutting body 21 and the substrate 22. The biasing device is arranged to bias the cutting body 21 towards the parking position, so that the circular saw 20 can be maintained at the parking position when no external force is applied to the circular saw 20, thereby improving safety. Further, the plunge circular saw 20 includes a locking device for locking the cutting body 21 in the parking position, which can be unlocked by an unlocking block 28 disposed on the handle 25, allowing the cutting body 21 to be pivotable relative to the substrate 22, so that the user moves the cutting body 21 to the cutting position for cutting. The plunge circular saw 20 further includes a protective cover 21b fixedly disposed on the substrate 22. The protective cover 21b covers the periphery of the circular saw blade 24 when in the parking position at the cutting body 21, so as to prevent teeth on the circular saw blade 24 from coming into contact with foreign objects and posing a danger.

The plunge circular saw 20 of the present invention also includes a limiting device 29 which limits the cutting depth. The limiting device 29 is arranged to limit the pivoting amplitude of the cutting body 21 relative to the substrate 22, and can vary the cutting depth by adjusting the limiting device 29. According to FIG. 2, the limiting device 29 is composed of an arcuate guide rail 29a and a stopper 29b slidable relative to the arcuate guide rail 29a. The arcuate guide rail 29a is fixedly connected to the substrate 22 and extends upward, and a portion of the arcuate guide rail 29a is inserted into a groove provided in the housing 21a. The inserted depth thereof is depending on the angular position of the cutting body 21 relative to the substrate 22. The arcuate guide rail 29a is provided with an elongated slot, and the stopper 29b is detachably fixed to the arcuate guide rail 29a along the slot. As shown in FIG. 4, the limiting device 29 is arranged such that when the cutting body 21 moves to the cutting position, an abutting edge 21c on the housing abuts against the edge of the stopper 29b, thereby preventing the cutting body 21 from further suspending downward to limit the cutting depth.

Further, the cutting depth of the plunge circular saw 20 can be varied by changing the position of the stopper 29b on the arcuate guide rail 29a. The arcuate guide rail 29a is further provided with a measurement index for allowing the user to know the set cutting depth from the position of the stopper 29b for further adjustment.

Although the present specification has been described in embodiments, not each embodiment includes only one independent technical solution. The manner of description of the specification is merely for the sake of clarity, and a person skilled in the art should consider the specification as a whole. The technical solutions of each embodiment may also be combined appropriately to form other embodiments which can be understood by a person skilled in the art. The scope of the invention is defined by the appended claims other than the specification mentioned above. Therefore it is intended that all changes that fall within the meaning and scope of equivalents of the claims fall into the scope of the invention.

The present invention is not limited to the details of the above-described exemplary embodiments to a person skilled in the art, and the present invention can be implemented in other specific forms without departing from the spirit or essential characteristics of the present invention. Accordingly, the above-described embodiments are to be considered as illustrative and not restrictive.

1. A plunge circular saw, comprising a cutting body and a substrate pivotally connected to the cutting body, the cutting body comprising:
a housing;
at least one handle provided on the housing;
a motor received within the housing;
a circular saw blade mechanically connected to the motor;
a battery pack electrically connected to the motor, and
a hinge for pivotally connecting the cutting body to the substrate,
wherein the battery pack is detachably mounted to a trailing end of the cutting body, the cutting body pivotable relative to the substrate by the hinge and movable between a cutting position and a parking position, the hinge disposed at a position between the motor or the circular saw blade and the battery pack.

2. The plunge circular saw according to claim 1, wherein the hinge is disposed at a position closer to the battery pack than the motor.

3. The plunge circular saw according to claim 1, further comprising a limiting device for limiting the cutting depth, the limiting device arranged to limit a pivoting amount of the cutting body relative to the substrate.

4. The plunge circular saw according to claim 3, wherein the cutting depth is adapted to be varied by adjusting the limiting device.

5. The plunge circular saw according to claim 1, further comprising a biasing device disposed to bias the cutting body toward the parking position.

6. The plunge circular saw according to claim 1, wherein the biasing device is a compression spring disposed between the cutting body and the substrate.

7. The plunge circular saw according to claim 5, further comprising a locking device for locking the cutting body in the parking position, the locking device adapted to be unlocked by an unlocking block disposed on the handle to allow the cutting body to pivot relative to the substrate.

8. The plunge circular saw according to claim 1, further comprising a gearbox mechanically connected to the motor and the circular saw blade.

9. The plunge circular saw according to claim 1, further comprising a protective cover fixedly disposed on the substrate, the protective cover covering the periphery of the circular saw blade when the circular saw blade is in the parking position.

10. The plunge circular saw according to claim 1, further comprising an auxiliary handle disposed in front of the handle.
